(19) United States
(12) Patent Application Publication
(10) Pub. No.: US 2022/0226971 A1
(43) Pub. Date: Jul. 21, 2022

(54) Bulletproof Tools

(71) Applicant: Travis James Reed, Sahuarita, AZ (US)

(72) Inventor: Travis James Reed, Sahuarita, AZ (US)

(21) Appl. No.: 17/151,139

(22) Filed: Jan. 16, 2021

(51) Int. Cl. B25B 13/48; B25B 5/16

(52) U.S. Cl. CPC B25B 13/48; B25B 5/16

(57) ABSTRACT

Bulletproof Tools reimagines traditional tools using a far superior material. The use of abrasion resistant metal in the manufacturing of tools is a natural progression in the use of new materials to significantly improve traditional tools durability and strength. Traditional tools use forged material to manufacture their tools. Forged metal is only half as strong as ar500.

### CROSS-REFERENCE TO RELATED APPLICATIONS

My patent cross-references some common tools such as combination wrench, combination socket, socket wrench, vise grips, locking pliers, crescent wrench, pipe wrench and hammers.

### STATEMENT REGARDING FEDERALLY SPONSORED RESEARCH OR DEVELOPMENT

My invention is not sponsored by any federal entity.

### THE NAMES OF THE PARTIES TO A JOINT RESEARCH AGREEMENT

I do not have any joint research agreements with any business or person.

### REFERENCE TO A “SEQUENCE LISTING”, A TABLE, OR A COMPUTER PROGRAM LISTING APPENDIX SUBMITTED ON A COMPACT DISC AND AN INCORPORATION-BY-REFERENCE OF THE MATERIAL ON THE COMPACT DISC

There is no reference to a listing, a table, or program on a compact disc regarding my invention.

### STATEMENT REGARDING PRIOR DISCLOSURES BY AN INVENTOR OR JOINT INVENTOR

There is not a joint inventor or any statements, disclosures from co-inventors.

### BACKGROUND OF THE INVENTION

### (1) Field of the Invention

The invention is in the hand tool, industrial tool, and general tools field.

### (2) Description of Related Art Including Information Disclosed Under 37 CFR1.97 and 37 CFR 1.98

All information and art disclosed in this invention will be of the technical specifications of material used to manufacture a wide variety of tools. My invention revolves around the material used to make the Bulletproof Tools. The material used in my inventions is called abrasion resistant steel also known as ar400, ar500, ar1100. The properties of this metal are far superior to any material used to develop tools presently.

### BRIEF SUMMARY OF THE INVENTION

Bulletproof Tools are made with abrasion resistant metal which is twice as strong as forged metals used in the manufacture of tools presently. The use of abrasion resistant metal in my tools increases the durability and strength of my tools considerably. In addition, the tensile strength of my tools is 200,000 psi. compared to forged tools 113,000 psi. Abrasion resistant metal is known for its hardness and durability. Bulletproof Tools will not bend or break at higher torque levels when compared to traditional materials used for tools.

### BRIEF DESCRIPTION OF THE SEVERAL VIEWS OF THE DRAWING

All drawings or spec. sheets will pertain to the differences in material used to manufacture Bulletproof tools compared to traditional manufacturing processes. My invention pertains to material used to develop my tools such as the combination wrench.

### DETAILED DESCRIPTION OF THE INVENTION

Bulletproof tools are manufactured from abrasion resistant material such as ar400, ar500, ar550. The abrasion resistant material is laser cut with a cot laser using a dxf file programed in solid works or AutoCAD. My tools are not only more durable but nearly twice as strong as traditional manufacturing methods. Abrasion resistant material was initially designed for the use in the mining industry due to its strength and durability. My contention is not the function or design of the tool, but the material used to manufacture tool. The nature of abrasion resistant material lends itself to being used in the manufacture of a far superior tool when compared to traditional methods using forged materials.

41xx steel is a family of SAE steel grades, as specified by the Society of Automotive Engineers (SAE). Alloying elements include chromium and molybdenum, and as a result these materials are often informally referred to as chromoly steel (common variant stylings include chrome-moly, cro-moly, CrMo, CRMO, CR-MOLY, and similar). They have an excellent strength to weight ratio and are considerably stronger and harder than standard 1020 steel, but are not easily welded, requiring thermal treatment both before and after welding to avoid cold cracking. [1] While these grades of steel do contain chromium, it is not in great enough quantities to provide the corrosion resistance found in stainless steel. Examples of applications for 4130, 4140 and 4145 include structural tubing, bicycle frames, gas bottles for transportation of pressurized gases, firearm parts, clutch and flywheel components, and roll cages. 4150 stands out as being one of the steels accepted for use in M16 rifle and M4 carbine barrels by the United States military. These steels are also used in aircraft parts and therefore 41xx grade structural tubing is sometimes referred to as “aircraft tubing.

Material Condition Tensile strength [psi (MPa)] Yield strength [psi (MPa)] Elongation at fracture, 2-inch gauge [%] Hardness, Rockwell

4130 Cold drawn, normalized [3] 85,000-110,000 psi (590-760 MPa) 70,000-85,000 psi (480-590 MPa) 20-30 B 90-96

4142 Hot rolled, annealed [3] 90,000-100,000 psi (620-690 MPa) 60,000-70,000 psi (410-480 MPa) 20-30 B 90-95

Cold drawn, annealed [3] 105,000-120,000 psi (720-830 MPa) 85,000-95,000 psi (590-660 MPa) 15-25 B 96-100

4150 Hot rolled, annealed [3] 90,000-110,000 psi (620-760 MPa) 65,000-75,000 psi (450-520 MPa) 20-30 B 90-96

1. My claim is the use of any abrasion resistant metal used in the manufacture of any wrench, combination wrench, socket wrench, socket, pliers, locking pliers, c-clamps, monkey wrench, crescent wrench, and hammer head. There are different grades of abrasion resistant metal ar400, ar500, ar550, ar600, ar1100, corresponding to their respective hardness. My claim is any abrasion resistant metal in the manufacture of the above described tools.
